(19) United States
(12) Patent Application Publication
(10) Pub. No.: US 2025/0053279 A1
(43) Pub. Date: Feb. 13, 2025

(54) METHOD, APPARATUS, DEVICE AND STORAGE MEDIUM FOR INFORMATION PRESENTATION

(71) Applicant: Beijing Youzhuju Network Technology Co., Ltd., Beijing (CN)

(72) Inventors: Jing LIN, Beijing (CN); Duanliang ZHOU, Beijing (CN); Long RU, Beijing (CN); Chao WU, Beijing (CN); Conghai YAO, Beijing (CN); Yelun LIU, Beijing (CN); Bin QIAN, Beijing (CN); Siyi YE, Beijing (CN); Jie WANG, Beijing (CN); Wenhao LI, Beijing (CN); Wenjing LIU, Beijing (CN); Shengan CAI, Beijing (CN); Tingting YANG, Beijing (CN); Yiwei WANG, Beijing (CN); Junjun YAO, Beijing (CN); Yifei QIU, Beijing (CN); Ju YANG, Beijing (CN); Yunfei SONG, Beijing (CN); Chuan ZHAO, Beijing (CN); Xianhui WEI, Beijing (CN); Xiaofeng WANG, Beijing (CN); Jianwen WU, Beijing (CN); Meng CHEN, Beijing (CN); Mang WANG, Beijing (CN); Peng HE, Beijing (CN); Kaijian LIU, Beijing (CN); Liangpeng XU, Beijing (CN); Yuhang LIU, Beijing (CN); Xiang XIAO, Beijing (CN); Runyu CHEN, Beijing (CN); Da LEI, Beijing (CN); Xiangnan LUO, Beijing (CN); Zheng PENG, Beijing (CN); Shaolong CHEN, Beijing (CN); Binghua XU, Beijing (CN); Hongtao XUE, Beijing (CN); Guorong ZHU, Beijing (CN); Qinglin XU, Beijing (CN); Pingping HUANG, Beijing (CN); Hongtao HU, Beijing (CN)

(21) Appl. No.: 18/799,750

(22) Filed: Aug. 9, 2024

(30) Foreign Application Priority Data
Aug. 10, 2023 (CN) 202311010717.X

(51) Int. Cl. G06F 3/0483; G06F 3/0484; G06F 40/166; G10L 25/57

(52) U.S. Cl. CPC G06F 3/0483; G06F 3/0484; G06F 40/166; G10L 25/57

(57) ABSTRACT

The embodiments of the disclosure provide a method, apparatus, device and storage medium for presenting information, which relate to the technical field of computers. The method includes: obtaining object search information, in response to the object search information being object category information, determining a target object category corresponding to the object search information, and presenting object information of a plurality of target objects corresponding to the target object category in a search result presentation page; where all the plurality of target objects are different, and object information of a target object includes object attribute information and image resource information of the target object. By employing the above technical solution, when the user is searching the object category, object information of a plurality of target objects different from each other corresponding to the target object category is presented in the search result page.

### CROSS REFERENCE

The present application claims priority to Chinese Patent Application No. 202311010717.X, filed on Aug. 10, 2023 and entitled “METHOD, APPARATUS, DEVICE AND STORAGE MEDIUM FOR INFORMATION PRESENTATION,”, the entirety of which is incorporated herein by reference.

### FIELD

The embodiments of the present disclosure relate to the technical field of computers, and in particular, to a method, an apparatus, a device and storage medium for presenting information.

### BACKGROUND

With the rapid development of information technology and the popularization of mobile Internet, users can obtain more and more rich information. In order to improve the efficiency of obtaining information, users are usually supported to search for information by inputting search keywords and the like, and the information contained in the search result is displayed to the users.

### SUMMARY

The embodiments of the present disclosure provide a method, an apparatus, a device and storage medium for presenting information, which can optimize existing information presentation solutions.

In a first aspect, the embodiments of the present disclosure provide a method for presenting information, comprising:
obtaining object search information;
in response to the object search information being object category information, determining a target object category corresponding to the object search information, and presenting object information of a plurality of target objects corresponding to the target object category in a search result presentation page; wherein all the plurality of target objects are different, and object information of a target object comprises object attribute information and image resource information of the target object.

In a second aspect, the embodiments of the present disclosure further provide an apparatus for presenting information, comprising:
an object search information obtaining module, configured to obtain object search information;
an object information presentation module, configured to in response to the object search information being object category information, determine a target object category corresponding to the object search information, and present object information of a plurality of target objects corresponding to the target object category in a search result presentation page; wherein all the plurality of target objects are different, and object information of a target object comprises object attribute information and image resource information of the target object.

In a third aspect, the embodiments of the present disclosure further provide an electronic device, comprising:
one or more processors;
a storage apparatus, configured to store one or more programs, wherein the one or more programs, when executed by the one or more processors, cause the one or more processors to implement the method for presenting information provided by the embodiments of the present disclosure.

In a fourth aspect, the embodiments of the present disclosure further provide a storage medium comprising computer-executable instructions, wherein when executed by a computer processor, the computer-executable instructions are configured to perform the method for presenting information provided the embodiments of the present disclosure.

In the solution for presenting information provided by the embodiments of the present disclosure, the object search information is obtained, in response to the object search information being object category information, a target object category corresponding to the object search information is determined, and object information of a plurality of target objects corresponding to the target object category is presented in a search result presentation page; wherein all the plurality of target objects are different, and object information of a target object comprises object attribute information and image resource information of the target object. By adopting the above technical solution, when the user is searching for an object category, object information of a plurality of target objects different from each other corresponding to the target object category is presented in the search result page, and the object information comprises the object attribute information and the image resource information of the target object, which facilitates the user to quickly locate a satisfying search result in the search result presentation page according to the object information, improves the efficiency of the object search and enhances the user experience.

### BRIEF DESCRIPTION OF DRAWINGS

The above and other features, advantages, and aspects of various embodiments of the present disclosure will become more apparent in combination with the accompanying drawings and with reference to the following detailed description. Throughout the drawings, the same or similar reference symbols refer to the same or similar elements. It should be understood that the drawings are schematic, and elements are not necessarily drawn to scale.

FIG. 1 is a schematic flowchart of a method for presenting information provided by embodiments of the present disclosure;

FIG. 2 is a schematic diagram of an interface provided by embodiments of the present disclosure;

FIG. 3 is a schematic flowchart of a method for presenting information provided by embodiments of the present disclosure;

FIG. 4 is a schematic diagram of interface interaction provided by embodiments of the present disclosure;

FIG. 5 is a schematic structural diagram of an apparatus for presenting information provided by embodiments of the present disclosure;

FIG. 6 is a schematic structural diagram of an electronic device provided by embodiments of the present disclosure.

### DETAILED DESCRIPTION

The embodiments of the present disclosure will be described in more detail below with reference to the accompanying drawings. Although certain embodiments of the present disclosure are shown in the drawings, it would be appreciated that the present disclosure may be implemented in various forms, and should not be interpreted as limited to the embodiments set forth herein. On the contrary, these embodiments are provided for a more thorough and complete understanding of the present disclosure. It would be appreciated that the accompanying drawings and embodiments of the present disclosure are only for illustrative purposes and are not intended to limit the scope of protection of the present disclosure.

It should be understood that the steps recited in the implement method of the present disclosure may be performed in different orders, and/or in parallel. Furthermore, the implement method may include additional steps and/or omit the steps shown by performing. The scope of the present disclosure is not limited in this respect.

As used herein, the term “comprising” and its variations would be appreciated as open inclusion, i.e., “including but not limited to”. The term “based on” represents “at least partially based on”. The term “one embodiment” represents “at least one embodiment”; the term “another embodiment” represents “at least one further embodiment”; the term “some embodiments” represents “at least some embodiments”. The related definition of other terms would be included in the following descriptions.

It should be noted that concepts such as “first” and “second” mentioned in the present disclosure are only used for distinguishing different apparatuses, modules, or units, and are not used for limiting the order of functions performed by the apparatuses, modules, or units or the relation of interdependence.

It should be noted that the modification of “one” and “a plurality of” mentioned in the present disclosure is illustrative and not limiting, and those skilled in the art should understand it as “one or more” unless the context clearly indicates.

The names of messages or information interaction between a plurality of devices in the embodiments of the present disclosure are for illustrative purposes only and are not used to limit the scope of these messages or information.

It is to be understood that, before using the technical solutions disclosed in each embodiment of the present disclosure, users should be informed of the type, the scope of use, the use scenario, etc. of the personal information involved in the present disclosure in an appropriate manner according to the relevant laws and regulations and the authorization of the user should be obtained.

For example, in response to receiving an active request from a user, a prompt message is sent to the user to explicitly prompt the user that the requested operation by the user will need to obtain and use the user's personal information. Therefore, the user may autonomously select whether to provide personal information to the software or the hardware such as an electronic device, an application, a server or a storage medium that perform the operation of the technical solution of the present disclosure according to the prompt information.

As an optional but non-limiting implementation, in response to receiving the active request of the user, the manner of sending the prompt information to the user may be, for example, a pop-up window in which prompt information may be presented in text. In addition, the pop-up window may further contain selection controls for users to choose “agree” or “disagree” to provide personal information to electronic devices.

It may be understood that the above notification and acquisition of user authorization process are merely schematic, and do not limit the implementations of the present disclosure. Other manners that meet related laws and regulations may also be applied to the implementation of the present disclosure.

It may be understood that the data involved in the present technical solution (including but not limited to the data itself, the acquisition or use of the data) should follow the requirements of the corresponding laws and regulations and related provision.

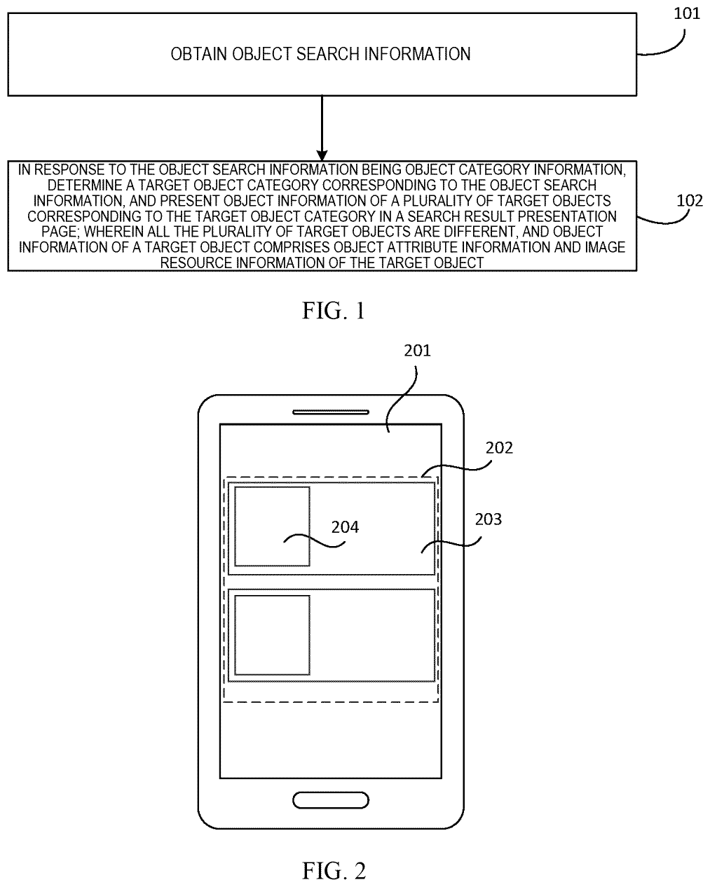

FIG. 1 is a schematic flowchart of a method for presenting information provided by embodiments of the present disclosure, and the embodiments of the present disclosure are applicable to a situation of presenting information. The method may be performed by an apparatus for presenting information, and the apparatus may be implemented in a form of software and/or hardware, optionally, implemented by an electronic device. The electronic device may be a mobile terminal, such as a mobile phone, a smart watch, a tablet computer, a personal digital assistant and the like, or may be a device such as a personal computer (PC) terminal, a server and the like.

As shown in FIG. 1, the method comprises:

Step 101: obtaining object search information.

In the embodiments of the present disclosure, the object search information may be understood as information to be searched for the predetermined object, which may be input by the current user. The predetermined object may include, for example, a commodity, an item, a service, information, attractions, news, a person and so on. The object search information may specifically be a search keyword used to indicate a characteristic (for example, an attribute or a category) of the predetermined object. By way of example, the user may input object search information based on a predetermined page, for example, the predetermined page may include a search box, and after triggering the search box, the user may input the object search information. The predetermined page may be specifically a page that provides an object search function in the predetermined application.

Step 102: in response to the object search information being object category information, determining a target object category corresponding to the object search information, and present object information of a plurality of target objects corresponding to the target object category in a search result presentation page; wherein all the plurality of target objects are different, and object information of a target object comprises object attribute information and image resource information of the target object.

For example, when the user performs a search, the search target may not be definite. Assuming that the predetermined object is a commodity, the user may want to buy a bottle of essence water, but is not sure to buy which brand and which model of essence water sold by which store. Therefore, “essence water” may be input as the object search information. For example, if the object search information does not direct to a specific predetermined object, i.e., it is not possible to determine a unique predetermined object based on the object search information, such as “essence water” in the above example, the object search information may be considered as object category information. If the object search information is object category information, the target object category corresponding to the object search information may be determined, and the target object category may be considered as an object category that the current user wants to search.

As an example, in the search result presentation page, object information of a plurality of target objects corresponding to the target object category is presented, and the plurality of target objects are different from each other, for example, the same kind of commodities sold by different merchants may not appear.

As an example, the object attribute information of the target object may include information such as an object identifier (for example, a commodity name), a brand, a model, a material, a component, or a selling point of the commodity. The image resource information may include information of resources such as an image and/or a video associated with the target object, such as a schematic diagram of a commodity or an explanation video of a commodity.

In the method for presenting information provided by the embodiments of the present disclosure, the object search information is obtained, in response to the object search information being object category information, a target object category corresponding to the object search information is determined, and object information of a plurality of target objects corresponding to the target object category is presented in a search result presentation page; wherein all the plurality of target objects are different, and object information of a target object comprises object attribute information and image resource information of the target object. By adopting the above technical solution, when the user is searching the object category, object information of a plurality of target objects different from each other corresponding to the target object category is presented in the search result page, the object information comprises the object attribute information and the image resource information of the target object, which is convenient for the user to quickly locate the satisfactory search result in the search result presentation page according to the object information, thus improving the efficiency of object search and enhancing the user experience.

Alternatively, if the object search information is predetermined object identifier information, that is, which directs to a specific predetermined object, the corresponding predetermined object information may be presented in a search result presentation page.

In some embodiments, the presenting object information of a plurality of target objects corresponding to the target object category in a search result presentation page comprises: presenting a set of object units in a search result presentation page, wherein the set of object units comprises a plurality of object units, the object unit is configured to present object information of a target object corresponding to the target object category, the target object corresponds to a plurality of predetermined objects belonging to a same object sub-category, and different predetermined objects correspond to different object sources. Therefore, the predetermined objects belonging to the same object sub-category from different sources are aggregated as the target object, and the target object is presented in the form of the object unit of the target object, so that the user may quickly position the satisfactory search result without the need of paying attention to the specific object source, further improving the efficiency of object search and enhancing the user experience.

As an example, one target object corresponds to one object sub-category. The predetermined object may be classified based on a predetermined key attribute, that is, different predetermined key attributes correspond to different object sub-categories. As an example, taking a commodity as an example, one standard product unit (SPU) may correspond to one object sub-category, the SPU is a commodity information aggregation unit, and the predetermined key attribute may be a brand and a model, for example, the essence water of brand A model a, the essence water of brand A model b, and the essence water of brand B model c, correspond to different object sub-categories, respectively. As an example, with information as an example, one event may correspond to one object sub-category, the predetermined key attribute may be an event element (for example, a time, a place, and a person of the event), for example, an xx concert held in place X, an xx concert held in place Y, and an xx concert held in place Z correspond to different object sub-categories, respectively.

As an example, for a same object sub-category, there may be one or more predetermined objects, different predetermined objects correspond to different object sources, and predetermined objects of the same object sub-category may be aggregated as a target object, that is, the target object may be understood as an aggregation object. The object source may be understood as an object source of the predetermined object, that is, a provider of the predetermined object. Taking a commodity as an example, the object source may be a merchant or a store selling the commodity, for example, the essence water of brand A model a may be sold by multiple merchants at the same time, and the essence water of brand A model a sold by the multiple merchants is aggregated as the target object. Taking information as an example, the object source may be an information publishing platform, for example, there may be multiple information publishing platforms at the same time publishing relevant information of the xx concert held in place X, and the relevant information published by the multiple information publishing platforms may be aggregated as a target object.

As an example, when the object search information is object category information, by searching with the object search information, many predetermined objects in the target object category may be searched, the searched predetermined object are classified based on predetermined key attributes, and predetermined objects belonging to the same object sub-category are aggregated as a corresponding target object. As the example above, assuming that the object search information is essence water, many kinds of essence water sold by many merchants can be searched, the searched essence water is classified by using the brands and models as predetermined key attributes, and essence water belonging to the same brand and model is aggregated as a corresponding target object.

As an example, the target object and the object unit may be in a one-to-one relationship. The object unit may be understood as a page element for presenting object information of a corresponding target object, and the specific expression form and style are not limited, for example, may be in a form of a card, and may be a commodity card for a commodity.

In some embodiments, an image resource which the image resource information belongs to comprises an associated video of the target object, the object unit comprises a video presentation area, and the video presentation area is configured to present a video cover of the associated video and/or play the associated video. Therefore, the user can quickly know the target object in the search result in multiple aspects.

As an example, the object unit may include a plurality of presentation areas, and different presentation areas are used to present different target object information. The object unit includes a video presentation area of an associated video of a target object corresponding to the object unit. The associated video of the target object may include associated content (such as explanation content or live content) of the target object, the associated video may include a video that references the target object, and as for an example of a commodity, the associated video may be an explanation video, may be a video resource of a resource library corresponding to the predetermined application, for example, may be a video work or a live broadcast segment published by a user using the predetermined application. The video presentation area is used for presenting a video cover of an associated video and/or playing an associated video. The video cover may be, for example, a video frame (such as a first frame) of a predetermined frame sequence number in the associated video or a picture set by a publisher of the associated video. The object unit may further include other presentation areas, which may be used to present object attribute information of the target object.

In the embodiments of the present disclosure, a set of object units are presented in the search result presentation page, and the search result presentation page may be a page used to present the search result in the predetermined application, and may be the same page or different page from the predetermined page. The set of object units may be configured with a predetermined presentation amount, and the predetermined presentation number may be understood as an upper limit of an object unit initially presented in the search result presentation page. For example, the predetermined presentation amount is 3, in the case of obtaining 1 target object after searching, 1 object unit may be presented; in the case of obtaining 3 target objects after searching, 3 object units may be presented; and in the case of obtaining 5 target object after searching, 3 object units may be presented firstly.

Optionally, the method may further include: in response to a trigger operation for the video presentation area, entering a video playing page, and playing a corresponding associated video in the video playing page. Therefore, the user may view more complete video content of the associated video in the video playing page, and the video playing page may specifically be a video details page.

FIG. 2 is a schematic diagram of an interface provided by embodiments of the present disclosure. As shown in FIG. 2, a set of object units 202 is presented in a search result presentation page 201, in an example in which the set of object units 202 includes 2 object units 203, the object unit 203 includes a video presentation area 204 of an associated video of the corresponding target object, and object attribute information of the target object may be presented in a presentation area in the object unit 203 except for the video presentation area 204.

In some embodiments, the associated video comprises a video satisfying a predetermined condition and containing an explanation content of the target object, wherein the predetermined condition is determined based on a video popularity attribute. As a result, an appropriate associated video can be selected for viewing by the current user, which further improving the efficiency of object search for the user.

As an example, there may be a plurality of candidate associated videos of the target object, and the associated video may be selected from the plurality of candidate associated videos according to a predetermined condition. The video popularity attribute may be determined by parameter values of related video associated parameters, for example, a video playback amount, a video endorsement amount, or a video forwarding rate.

In some embodiments, object attribute information of the target object comprises target aggregation information, and the target aggregation information is obtained based on aggregating predetermined object attribute information of a plurality of corresponding predetermined objects in respective object sources. As a result, the overall situation of the target object can be presented to the user by presenting the target aggregation information in the object unit, which further helps the user to quickly locate the required search result, and improves the efficiency of object search.

As an example, the predetermined object attribute information may include related information of a predetermined object associated with the object source, that is, the predetermined object attribute information of the predetermined object may be different because of from different object sources. Taking the commodity as an example, for the same kind of commodity (that is, different predetermined object corresponding to the target object), the selling price, the sales volume, the amount of the repurchasing people, and the amount of positive comments of this commodity in different merchants may be all different, and the foregoing information may be predetermined object attribute information, and the specific aggregation manner is not limited, for example, taking an average value, a median value, a maximum value or a minimum value, and for example, calculating a sum value, etc., after aggregating the predetermined object attribute information, for example, an average selling price, a sum of sales volumes, the amount of accumulated repurchases, a total amount of positive comments, and the like may be obtained, which is convenient for the user to select and purchase commodities with reference to the target aggregation information.

In some embodiments, after presenting the set of object unit in the search result presentation page, the method further includes: automatically playing an associated video in at least one object unit in the set of object unit. Therefore, by automatically playing the associated video, the manual operation of the user may be reduced, so that the user can view the associated video more conveniently.

As an example, at the same moment, the associated video in one object unit may be automatically played, thereby improving the video watching experience. Optionally, a pause control may be presented in the search result presentation page, and the associated video is paused in response to a trigger operation of the user for the pause control.

Optionally, the object units in the set of object units are presented sequentially according to a target order. The target order may be determined according to a predetermined ordering manner, for example, parameters of one or more dimensions may be set, parameter values of a target object corresponding to the object unit in each dimension are determined, corresponding scores are determined according to parameter values of a single dimension or weighted statistical values of parameter values of different dimensions, and are sorted according to scores from big to small. Optionally, the target order is associated with the target aggregation information. For example, the target aggregation information includes a sum of selling amounts, and may be sorted according to the sum of selling amounts from high to low to determine a target order. Optionally, if the target aggregation information does not include a sum of the selling amounts, the sum of selling amounts may also be a parameter of one above dimension.

As an example, the object unit for automatically playing the associated video may be an object unit with a predetermined sequence number in the target order, or may be an object unit with target sequence number (for example, the first one) in the set of object units currently presented. Optionally, the user may browse more object units by inputting a sliding operation, and the object unit with the target sequence number may be dynamically changed.

In some embodiments, the object units in the set of object units are presented sequentially according to a target order; wherein the automatically playing the associated video in the at least one object unit in the set of object units comprises: automatically playing the associated video in each object unit in the set of object unit according to the target order sequentially, wherein the video cover of the corresponding associated video is presented in the video presentation area of the object unit to which the associated video in the unplayed state belongs. Therefore, automatic switching of video playing may be realized, and user operation is further reduced.

As an example, there may be a predetermined time interval between associated videos in different object units, and after the current associated video is completely played, the next associated video is automatically played after the predetermined time interval (for example, 1 minute). For example, the associated video in the first object unit is played automatically, after the playing is completed, and after the interval of 1 minute, the associated video in the second object unit is played automatically, and so on. Optionally, if the associated video of the last object unit in the set of object units currently presented has been already played, the automatic playing may be stopped, or the associated video in the first object unit may be replayed again.

In some embodiments, the object unit comprises explanation summary information of a corresponding associated video, the explanation summary information comprises text information corresponding to a target explanation speech in the associated video, and a corresponding explanation time of the target explanation speech in the associated video, and the target explanation speech is associated with a characteristic of the target object. In this way, the user can be helped to quickly view the characteristics of the target objects in the video, and the corresponding explanation screen may be viewed from the associated video with reference to the explanation time.

In an example of a commodity, the associated video is an explanation video, and the lecturer in the video may explain its characteristics when introducing the target object, in an example of essence water, for example, it can be “it may be absorbed by gently rubbing when putting on the face”. The target explanation time may be, for example, a start time of the target explanation speech in the associated video, and “mentioned at xx seconds” may be represented in the object unit, where “xx seconds” is the target explanation time.

In some embodiments, the object unit comprises at least one attribute identifier, and the attribute identifier is configured to represent an attribute which a corresponding target object has. In this way, the user can conveniently and explicitly know the attribute of the target object, which further improves the efficiency of object search.

As an example, the content in the attribute identifier may include a target attribute, and the target attribute may include, for example, a material or a component, and the like, in an example of a commodity, may further include information of selling point.

In some embodiments, the associated video and/or the attribute identifier is associated with a historical interaction operation of a current user. Therefore, a more appropriate associated video and/or attribute identifier may be presented to the user, which further improves the efficiency of object search of the current user. Optionally, the historical interaction operation may include, for example, a video viewing operation, an endorsement operation, or a collection operation.

As an example, when the associated video is associated with the historical interaction operation of the current user, the historical interaction operation of the current user may be added in the predetermined condition, for the same target object, different users may view different associated videos may be realized, and viewing experience of the user's associated video is improved.

In some embodiments, the method further includes: displaying a predetermined control in an associated area of the set of object units in the target page; updating the set of object units in response to a trigger operation for the predetermined control, wherein an amount of object units contained in the set of object units after updating is greater than an amount of object units contained in the set of object units before updating, and the set of object units after updating contains object units in the set of object units before updating. Thus, the user can view more object units of the target object matching the object search information.

As an example, when the set of object units are initially presented, presenting according to a predetermined presentation amount, if the predetermined presentation amount is 2.5, then 2.5 object units may be presented firstly, the target control may be, for example, “view more hot selling commodities”, and then expanded to be a target presentation amount of object units, for example, 10 object units are presented, and the user may switch the display of the object unit by a sliding operation.

In some embodiments, the method further includes: displaying a predetermined control in an associated area of the set of object units in the target page; presenting a first set of predetermined object information in response to a trigger operation for the predetermined control, wherein the first set of predetermined object information comprises predetermined object information of a plurality of predetermined objects matching the object search information. Therefore, the user may be supported to view the predetermined object information of the predetermined object matching the object search information which is not aggregated by triggering the predetermined control.

As an example, the predetermined object information of the predetermined object may include object source information, in an example of a commodity, it may include specific information of merchant or store. Taking the user searching for essence water above as an example, the first set of predetermined object may include predetermined object information corresponding to different kinds of essence water of different brands and different models sold by different merchants, and a specific presentation mode of the predetermined object information is not limited, also may be a form of a commodity card.

Optionally, the predetermined control is displayed after the target control is triggered. Optionally, the target control and the predetermined control are displayed at the same time.

In some embodiments, after presenting a set of object unit sets in a search result presentation page, the method further comprises: presenting, in response to a trigger operation for a first target object unit, an associated page of a target object source corresponding to a first target object which corresponds to the first target object unit, wherein the associated page is configured for use by a current user to perform a predetermined interaction operation for a predetermined object corresponding to the target object source. Therefore, the associated page of a certain specific object source can be quickly entered, so that the user can conveniently perform the predetermined interaction operation.

As an example, the target object source may be an object source selected from a plurality of object sources corresponding to the first target object unit employing a predetermined object selecting manner. For example, taking a commodity as an example, a store with a highest sales volume or an official store may be selected as a target object source. The associated page of the target object source may be, for example, a home page of the target object source or a detail page of a corresponding predetermined object of the target object source, and the predetermined interaction operation may be an interaction operation entered by the user in the associated page for the predetermined object, such as a purchase operation, a collection operation, a sharing operation, or a comment viewing operation.

In some embodiments, after presenting a set of object unit sets in a search result presentation page, the method further comprises: presenting, in response to a trigger operation for a second target object unit, a second set of predetermined object information, wherein the second set of predetermined object information comprises predetermined object information of a plurality of predetermined objects corresponding to a second target object which corresponds to the second target object unit. Therefore, the predetermined object information of predetermined objects which are not aggregated corresponding to the target object in the second target object unit may be presented to the user, so that the user may conveniently select the object information corresponding to a specific certain object source for a further operation.

As an example, when a user triggers a certain object unit, predetermined object information of a predetermined object corresponding to different object sources may be presented. Taking the commodity as an example, after the user triggers the commodity card corresponding to the essence water of the brand A model a, commodity information (predetermined object information) of the essence water of the brand A model a sold by different merchants may be presented.

In some embodiments, the method further comprises: presenting a set of labels in the search result presentation page, wherein the set of labels comprises at least two labels, the labels which are different correspond to a set of object units of different predetermined attribute dimensions, and the labels are configured to trigger presenting of a set of object units of a corresponding predetermined attribute dimension. Therefore, the set of object units may be distinguished according to the predetermined attribute dimension, the user can conveniently switch the presentation of the set of object units with different predetermined attribute dimensions by triggering the label control, and the efficiency of object search is further improved.

As an example, the predetermined attribute dimension may be set according to an attribute or a function of the predetermined object. Taking the commodity as an example, the predetermined attribute dimension of the essence water may include, for example, anti-aging, firming and brightening, spot-fading, and the like.

In some embodiments, a characteristic of the target object comprises a content of a label corresponding to a set of object units which corresponds to the target object. Therefore, the related target explanation speech may be searched from the associated video according to the content of the label, and the user can quickly know the explanation content related to the selected label by viewing the explanation summary information.

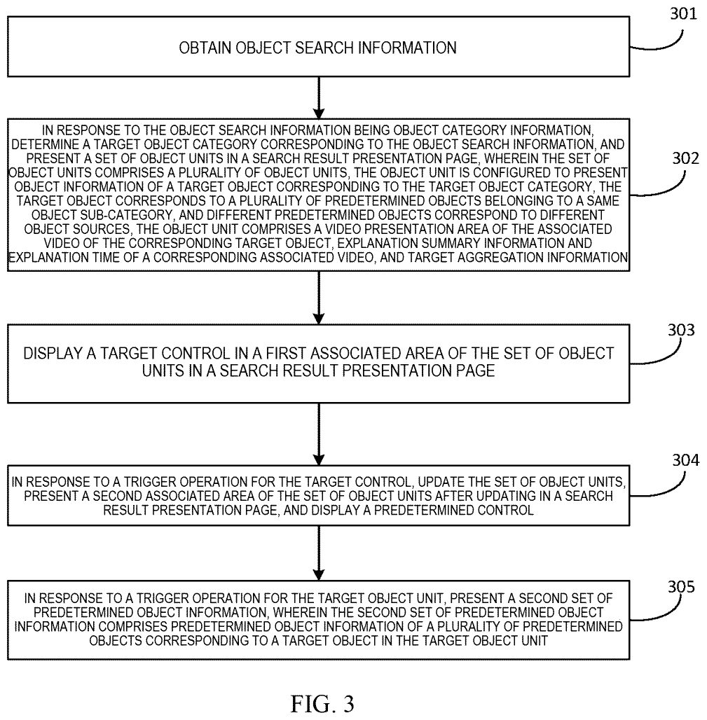

FIG. 3 is a schematic flowchart of a method for presenting information provided by embodiments of the present disclosure, the embodiments of the present disclosure are optimized based on various optional solutions in the above embodiments, specifically, the method comprises the following steps:

Step 301: obtaining object search information.

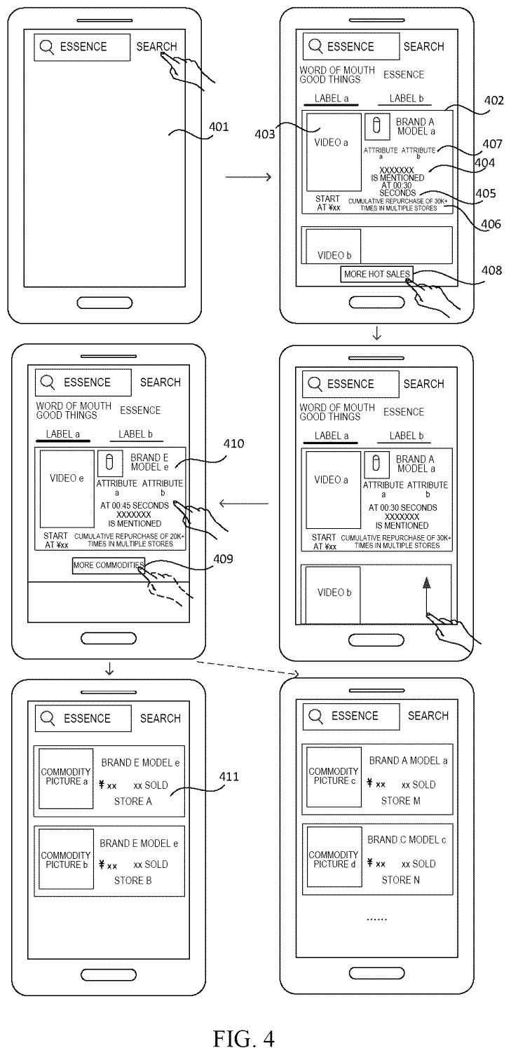

FIG. 4 is a schematic diagram of interface interaction provided by embodiments of the present disclosure. By way of example, there is a search box set in a search result presentation page 401, where object search information input by a user with a search box may be obtained, for example, after a user inputs “essence”, clicking a search button, then a search operation is triggered, and “essence” is obtained as the object search information.

Step 302: in response to the object search information being object category information, determining a target object category corresponding to the object search information, and present a set of object units in a search result presentation page, wherein the set of object units comprises a plurality of object units, the object unit is configured to present object information of a target object corresponding to the target object category, the target object corresponds to a plurality of predetermined objects belonging to a same object sub-category, and different predetermined objects correspond to different object sources, the object unit comprises a video presentation area of the associated video of the corresponding target object, explanation summary information and explanation time of a corresponding associated video, and target aggregation information.

As shown in FIG. 4, a set of object units are presented in the search result presentation page 401, the set of object units includes a plurality of object units 402 of a target object matching the object search information, and 1.5 is taken as an example in the figure, and more (predetermined amount) object units may be displayed in the actual application scenario. The object unit 402 includes the video presentation area of the associated video 403, the explanation summary information 404, the explanation time 405, the target aggregation information 406 (such as the “cumulative repurchase of 30k+ times in multiple stores” and the price “start at xx” in the figure), the attribute identifier 407, the target object name, and the target object schematic diagram (for example, the commodity photo) of the target object, and other information. The associated video and the attribute identifier are associated with a historical interaction operation of the current user.

Optionally, a set of labels (such as the label a and the label b in the figure) is presented in the search result presentation page, and the set of object units currently presented is the set of object units corresponding to the labels in the selected state currently. Optionally, in an initial state, the first label may be set to the selected state by default.

Optionally, the associated video in each object unit in the set of object units is automatically played sequentially according to the target order, wherein the video cover of the corresponding associated video is presented in the video presentation area of the object unit to which the associated video in the unplayed state belongs.

As an example, after representing the set of object units, the video a is automatically played firstly, after the playing is completed, and after the interval of 1 minute, the video b is automatically played, and so on. Optionally, if the user inputs a sliding operation in the playing process of the video a, and slides the object unit to which the video b belongs to the position of the object unit to which the video a belongs, the video b may be automatically switched to play without waiting for that the playing of the video a is completed.

Step 303: displaying a target control in a first associated area of the set of object units in a search result presentation page.

As an example, the target control 408 is presented under the presentation area (the first associated area) of the set of object units in the search result presentation page, as “more hot sales” shown in FIG. 4. Other content in the search result presentation page may also be presented under the target control, for example, a media content stream, the media content stream may include a plurality of pieces of media content, and the media content may include image content, video content, audio content, and the like, and may specifically include a picture work, a video work, a music piece, or live broadcast content published by a user using a predetermined application.

Step 304: in response to a trigger operation for the target control, updating the set of object units, present a second associated area of the set of object units after updating in a search result presentation page, and display a predetermined control.

An amount of object units contained in the set of object units after updating is greater than an amount of object units contained in the set of object units before updating, and the set of object units after updating contains object units in the set of object units before updating. The predetermined control is configured to trigger presenting object information flow, and the object information flow includes object information of a plurality of predetermined objects matching the object search information.

By way of example, after the user triggering the target control, more object units may be displayed, and when all the object units in the set of object units after updating cannot be presented in the search result presentation page, the user may view the object units which are not presented currently by inputting sliding operation, and display the predetermined control 409 under the set of object units after updating (the second associated area), for example, “more commodities” in the figure. After the user triggering the predetermined control 409, as shown by the dotted arrow in the figure, the first set of predetermined object information may be presented, such as the commodity information from different stores which is not aggregated matching the essence in the figure.

Step 305: in response to a trigger operation for the target object unit, presenting a second set of predetermined object information, wherein the second set of predetermined object information comprises predetermined object information of a plurality of predetermined objects corresponding to a target object in the target object unit.

As an example, if the user wants to view a predetermined object corresponding to the target object in a certain object unit, the target object unit may be triggered by clicking or the like, as the target unit 410 shown in the figure, and a second set of predetermined object information is presented, the second set of predetermined object information includes commodity information 411 (predetermined object information) of two stores (store A and store B) which sell the essence of brand E model c.

According to the method for presenting information provided by the embodiments of the present disclosure, when the user is searching for objects, the predetermined objects belonging to the same object sub-category from different sources are aggregated as the target object, and the target object is presented in the form of the object unit of the target object, so that the user can quickly locate a satisfactory search result in connection with relevant contents such as the associated video, the explanation summary information, the target aggregation information, the target attribute of the target object and so on, without paying attention to the specific object source, which improves the efficiency of object search and enhances the user experience. In addition, after selecting a certain object unit, the user may further view the predetermined object information corresponding to different object source, so as to facilitate the user for further interaction operations for the specific predetermined object.

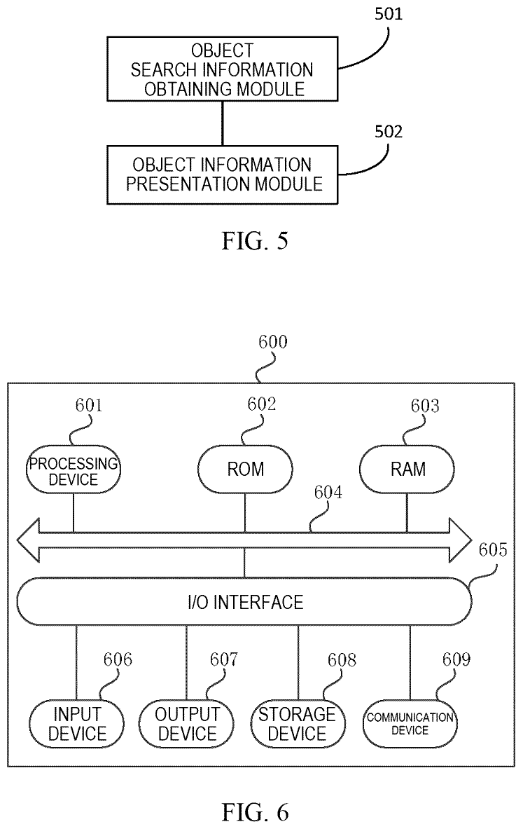

FIG. 5 is a schematic structural diagram of an apparatus for presenting information provided by embodiments of the present disclosure.

An object search information obtaining module 501 is configured to obtain object search information.

An object information presentation module 502 is configured to: in response to the object search information being object category information, determine a target object category corresponding to the object search information, and present object information of a plurality of target objects corresponding to the target object category in a search result presentation page; wherein all the plurality of target objects are different, and object information of a target object comprises object attribute information and image resource information of the target object.

In the apparatus for presenting information provided by the embodiments of the present disclosure, the object search information is obtained, in response to the object search information being object category information, a target object category corresponding to the object search information is determined, and object information of a plurality of target objects corresponding to the target object category is presented in a search result presentation page; wherein all the plurality of target objects are different, and object information of a target object comprises object attribute information and image resource information of the target object. By adopting the above technical solution, when the user is searching the object category, object information of a plurality of target objects different from each other corresponding to the target object category is presented in the search result page, the object information comprises the object attribute information and the image resource information of the target object, which is convenient for the user to quickly locate the satisfactory search result in the search result presentation page according to the object information, thus improving the efficiency of object search and enhancing the user experience.

Optionally, the presenting object information of a plurality of target objects corresponding to the target object category in a search result presentation page comprises: presenting a set of object units in a search result presentation page, wherein the set of object units comprises a plurality of object units, the object unit is configured to present object information of a target object corresponding to the target object category, the target object corresponds to a plurality of predetermined objects belonging to a same object sub-category, and different predetermined objects correspond to different object sources.

Optionally, an image resource which the image resource information belongs to comprises an associated video of the target object, the object unit comprises a video presentation area, and the video presentation area is configured to present a video cover of the associated video and/or play the associated video.

Optionally, the object attribute information of the target object comprises target aggregation information, and the target aggregation information is obtained based on aggregating predetermined object attribute information of a plurality of corresponding predetermined objects in respective object sources.

Optionally, the associated video comprises a video satisfying a predetermined condition and containing an explanation content of the target object, wherein the predetermined condition is determined based on a video popularity attribute.

Optionally, the object unit comprises at least one attribute identifier, and the attribute identifier is configured to represent an attribute which a corresponding target object has.

Optionally, the object unit comprises explanation summary information of a corresponding associated video, the explanation summary information comprises text information corresponding to a target explanation speech in the associated video, and a corresponding explanation time of the target explanation speech in the associated video, and the target explanation speech is associated with a characteristic of the target object.

Optionally, the associated video and/or the attribute identifier is associated with a historical interaction operation of a current user.

Optionally, the apparatus further comprises:
A predetermined control displaying module, configured to display a predetermined control in an associated area of the set of object units in the target page;
A first set presentation module, configured to present a first set of predetermined object information in response to a trigger operation for the predetermined control, wherein the first set of predetermined object information comprises predetermined object information of a plurality of predetermined objects matching the object search information.

Optionally, the apparatus further comprises:
An associated page presentation module, configured to, after presenting a set of object units in a search result presentation page, present, in response to a trigger operation for a first target object unit, an associated page of a target object source corresponding to a first target object which corresponds to the first target object unit, wherein the associated page is configured for use by a current user to perform a predetermined interaction operation for a predetermined object corresponding to the target object source;
Optionally, the apparatus further comprises:
A second set presentation module, configured to, after presenting a set of object units in a search result presentation page, present, in response to a trigger operation for a second target object unit, a second set of predetermined object information, wherein the second set of predetermined object information comprises predetermined object information of a plurality of predetermined objects corresponding to a second target object which corresponds to the second target object unit.

Optionally, the apparatus further includes:
A label presentation module, configured to present a set of labels in the search result presentation page, wherein the set of labels comprises at least two labels, the labels which are different correspond to a set of object units of different predetermined attribute dimensions, and the labels are configured to trigger presenting of a set of object units of a corresponding predetermined attribute dimension.

Optionally, a characteristic of the target object comprises a content of a label corresponding to a set of object units which corresponds to the target object.

The apparatus for presenting information provided in the embodiments of the present disclosure may perform the method for presenting information provided by any embodiment of the present disclosure, which has functional modules and beneficial effects corresponding to the execution method.

It should be noted that the units and modules comprised in the foregoing apparatus are only divided according to the function logic, but are not limited to the foregoing division, as long as the corresponding functions can be implemented; in addition, the specific names of the various functional units are only for case of distinguishing, and are not intended to limit the protection scope of the embodiments of the present disclosure.

FIG. 6 is a schematic structural diagram of an electronic device provided by embodiments of the present disclosure. Refer to FIG. 6 in the following, which shows a schematic diagram of an electronic device (such as the terminal device or server in FIG. 6) 600 according to an embodiment of the present disclosure. Terminal devices in the embodiments of this application may include, but are not limited to, mobile phones, notebook computers, digital broadcast receivers, PDA (Personal Digital Assistant, personal digital assistant), PAD (tablet computer), PMP (Portable Media Player, portable multimedia players), vehicle-mounted terminals (such as vehicle-mounted navigation terminals), etc., as well as fixed terminals such as digital TV (television, television), desktop computers, etc. The electronic device shown in FIG. 6 is only an example, and should not limit the function and application range of the embodiments of the present disclosure.

As shown in FIG. 6, the electronic device 600 may include a processing device (such as a central processing unit, a graphics processing unit, or the like) 601 that may perform various appropriate actions and processing according to a program stored in a read-only memory (ROM) 602 or a program loaded from a storage device 608 into a random-access memory (RAM) 603. In the RAM 603, various programs and data required for operation of the electronic device 600 are further stored. The processing device 601, the ROM 602, and the RAM 603 are connected to each other by using a bus 604. An edit/output (I/O) interface 605 is also connected to the bus 604.

Generally, the following devices may be connected to the I/O interface 605: input device 606 including, for example, a touchscreen, a touchpad, a keyboard, a mouse, a camera, a microphone, an accelerometer, and a gyroscope; output device 607 including, for example, a liquid crystal display (LCD), a loudspeaker and a vibrator; storage device 608 including, for example, a tape or a hard disk; and a communications device 609. The communications device 609 may allow the electronic device 600 to communicate wirelessly or wiredly with another device to exchange data. Although FIG. 6 shows an electronic device 600 with various devices, it should be understood that it is not required to implement or provide all shown devices. Alternatively, more or fewer devices may be implemented or provided.

In particular, according to the embodiments of the present disclosure, the process described above with reference to the flowchart may be implemented as a computer software program. For example, an embodiment of the present disclosure includes a computer software program product that includes a computer program carried on a readable medium, and the computer program includes program codes used to perform the methods shown in the flowchart. In such an embodiment, the computer program may be downloaded and installed from a network by using the communications device 609, or installed from the storage device 608, or installed from the ROM 602. When the computer program is executed by the processing device 601, the foregoing functions defined in the method in the embodiments of the present disclosure are executed.

The names of messages or information interacting between multiple apparatuses in embodiments of the present disclosure are for illustrative purposes only and are not intended to limit the scope of such messages or information.

The electronic device provided by the embodiments of the present disclosure and the method for presenting information provided in the foregoing embodiments belong to the same inventive concept, and technical details not described in detail in this embodiment may refer to the foregoing embodiments, and this embodiment has the same beneficial effects as the foregoing embodiments.

A computer storage medium is provided by embodiments of the present disclosure, having a computer program stored thereon, and when executed by a processor, the program implements the method for presenting information provided by the foregoing embodiments.

A computer program product is provided by embodiments of the present disclosure, including a computer program, and when executed by a processor, the program implements the method for presenting information provided by the foregoing embodiments.

It should be noted that the foregoing computer-readable medium in the present disclosure may be a computer-readable signal medium, a computer-readable storage medium, or any combination of the two. The computer-readable storage medium may be, for example, an electrical, magnetic, optical, electromagnetic, infrared, or semiconductor system, apparatus, or means, or any combination thereof. More specific examples of the computer-readable storage medium may include but are not limited to: an electrical connection having one or more conducting wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or means. In addition, in the present disclosure, the computer-readable signal medium may include a data signal propagated in a baseband or as a part of a carrier, which carries computer-readable program codes. Such a propagated data signal may be in multiple forms, including but not limited to an electromagnetic signal, an optical signal, or any suitable combination thereof. The computer-readable signal medium may further be any computer-readable medium other than the computer-readable storage medium, and the computer-readable signal medium may send, propagate, or transmit a program that is used by or in combination with an instruction execution system, apparatus, or means. The program code included in the computer-readable medium may be transmitted by using any suitable medium, including but not limited to: a wire, an optical cable, RF (radio frequency), or any suitable combination thereof.

In some embodiments, the client and the server can communicate by using any currently known or future-developed network protocol, for example, an HTTP (Hyper Text Transfer Protocol), and can be interconnected by a communication network of any form or any medium. Examples of the communication network include a local area network (“LAN”), a wide area network (“WAN”), an internet network (for example, the Internet), and an end-to-end network (for example, an ad hoc end-to-end network), and any currently known or future-developed network.

The foregoing computer-readable medium may be included in the foregoing electronic device; it may also exist separately without being assembled into the electronic device.

The foregoing computer-readable medium carries one or more programs, when the foregoing one or more programs are executed by the electronic device, causing the electronic device to: obtain object search information; in response to the object search information being object category information, determine a target object category corresponding to the object search information, and present object information of a plurality of target objects corresponding to the target object category in a search result presentation page; wherein all the plurality of target objects are different, and object information of a target object comprises object attribute information and image resource information of the target object.

Computer program codes for performing the operations of the present disclosure may be written in one or more programming languages or a combination thereof, such as object-oriented programming languages Java, Smalltalk, C++, and conventional procedural programming languages such as “C” or similar program design languages. The program codes may be executed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

The flowcharts and block diagrams in the accompanying drawings illustrate possible architectures, functions, and operations of systems, methods, and computer program products according to various embodiments of the present disclosure. In this regard, each block in a flowchart or block diagram may represent a module, program segment, or part of code that includes one or more executable instructions for implementing a specified logical function. It should also be noted that in some alternative implementations, functions marked in the block may also occur in different order than those marked in the accompanying drawings. For example, two blocks represented in succession may actually be executed in substantially parallel, and they may sometimes be executed in a reverse order, depending on the functions involved. It should also be noted that each block in the block diagram and/or flowchart and a combination of blocks in the block diagram and/or flowchart may be implemented by using a dedicated hardware-based system that performs a specified function or operation, or may be implemented by using a combination of dedicated hardware and a computer instruction.

The units described in embodiments of the present disclosure may be implemented either by means of software or by means of hardware. Where, the names of these units do not limit the units themselves under certain circumstances, for example, an object search information obtaining module can be described as “module for obtaining object search information”.

The functions described above herein may be performed, at least in part, by one or more hardware logic components. For example, and without limitation, example types of hardware logic components that may be used include: Field Programmable Gate Arrays (FPGAs), Application Specific Integrated Circuits (ASICs), Application Specific Standard Products (ASSPs), Systems on Chips (SOCs), Complex Programmable Logical device (CPLD) and so on.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. Machine-readable media may include, but are not limited to, electronic, magnetic, optical, electromagnetic, infrared, or semiconductor systems, apparatus or device, or any suitable combination of the foregoing. More specific examples of machine-readable storage media would include one or more wire-based electrical connection, portable computer disks, hard disks, random access memory (RAM), read only memory (ROM), erasable programmable read only memory (EPROM or flash memory), optical fiber, portable compact disk read-only memory (CD-ROM), optical storage device, magnetic storage device, or any suitable combination of the foregoing content.

According to one or more embodiments of the present disclosure, there is provided a method for presenting information, comprising:
Obtaining object search information;
In response to the object search information being object category information, determining a target object category corresponding to the object search information, and presenting object information of a plurality of target objects corresponding to the target object category in a search result presentation page; wherein all the plurality of target objects are different, and object information of a target object comprises object attribute information and image resource information of the target object.

According to one or more embodiments of the present disclosure, the presenting object information of a plurality of target objects corresponding to the target object category in a search result presentation page comprises:
Presenting a set of object units in a search result presentation page, wherein the set of object units comprises a plurality of object units, the object unit is configured to present object information of a target object corresponding to the target object category, the target object corresponds to a plurality of predetermined objects belonging to a same object sub-category, and different predetermined objects correspond to different object sources.

According to one or more embodiments of the present disclosure, an image resource which the image resource information belongs to comprises an associated video of the target object, the object unit comprises a video presentation area, and the video presentation area is configured to present a video cover of the associated video and/or play the associated video;
And/or,
Object attribute information of the target object comprises target aggregation information, and the target aggregation information is obtained based on aggregating predetermined object attribute information of a plurality of corresponding predetermined objects in respective object sources.

According to one or more embodiments of the present disclosure, the associated video comprises a video satisfying a predetermined condition and containing an explanation content of the target object, wherein the predetermined condition is determined based on a video popularity attribute;
And/or,
the object unit comprises at least one attribute identifier, and the attribute identifier is configured to represent an attribute which a corresponding target object has.

According to one or more embodiments of the present disclosure, the object unit comprises explanation summary information of a corresponding associated video, the explanation summary information comprises text information corresponding to a target explanation speech in the associated video, and a corresponding explanation time of the target explanation speech in the associated video, and the target explanation speech is associated with a characteristic of the target object.

According to one or more embodiments of the present disclosure, the associated video and/or the attribute identifier is associated with a historical interaction operation of a current user.

According to one or more embodiments of the present disclosure, the method further includes:
Displaying a predetermined control in an associated area of the set of object units in the target page;
Presenting a first set of predetermined object information in response to a trigger operation for the predetermined control, wherein the first set of predetermined object information comprises predetermined object information of a plurality of predetermined objects matching the object search information.

According to one or more embodiments of the present disclosure, further comprising: after presenting a set of object units in a search result presentation page,
Presenting, in response to a trigger operation for a first target object unit, an associated page of a target object source corresponding to a first target object which corresponds to the first target object unit, wherein the associated page is configured for use by a current user to perform a predetermined interaction operation for a predetermined object corresponding to the target object source;
And/or,
Presenting, in response to a trigger operation for a second target object unit, a second set of predetermined object information, wherein the second set of predetermined object information comprises predetermined object information of a plurality of predetermined objects corresponding to a second target object which corresponds to the second target object unit.

According to one or more embodiments of the present disclosure, further comprising:
Presenting a set of labels in the search result presentation page, wherein the set of labels comprises at least two labels, the labels which are different correspond to a set of object units of different predetermined attribute dimensions, and the labels are configured to trigger presenting of a set of object units of a corresponding predetermined attribute dimension.

According to one or more embodiments of the present disclosure, a characteristic of the target object comprises a content of a label corresponding to a set of object units which corresponds to the target object.

According to one or more embodiments of the present disclosure, there is provided an apparatus for presenting information, comprising
An object search information obtaining module, configured to obtain object search information;
An object information presentation module, configured to in response to the object search information being object category information, determine a target object category corresponding to the object search information, and present object information of a plurality of target objects corresponding to the target object category in a search result presentation page; wherein all the plurality of target objects are different, and object information of a target object comprises object attribute information and image resource information of the target object.

According to one or more embodiments of the present disclosure, there is provided an electronic device, comprising:
One or more processors;
A storage apparatus, configured to store one or more programs,
The one or more programs, when executed by the one or more processors, cause the one or more processors to implement the method for presenting information provided by the embodiments of the present disclosure.

According to one or more embodiments of the present disclosure, there is provided storage medium comprising computer-executable instructions, when executed by a computer processor, the computer-executable instructions are configured to perform the method for presenting information provided by the embodiments of the present disclosure.

The above description is only embodiments of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept, for example, a technical solution formed by interchanging the above features with (but not limited to) technical features with similar functions disclosed in the present disclosure.

Furthermore, although the operations are depicted using a particular order, this should not be construed as requiring that the operations be performed in the particular order shown or in sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject has been described using language specific to structural features and/or method logical actions, it should be understood that the subject limited in the appended claims is not necessarily limited to the particular features or actions described above. Rather, the particular features and actions described above are merely example forms of implementing the claims.

I/We claim:

1. A method for presenting information, comprising:
obtaining object search information;
in response to the object search information being object category information, determining a target object category corresponding to the object search information, and presenting object information of a plurality of target objects corresponding to the target object category in a search result presentation page; wherein all the plurality of target objects are different, and object information of a target object comprises object attribute information and image resource information of the target object.

2. The method of claim 1, wherein the presenting object information of a plurality of target objects corresponding to the target object category in a search result presentation page comprises:
presenting a set of object units in a search result presentation page, wherein the set of object units comprises a plurality of object units, the object unit is configured to present object information of a target object corresponding to the target object category, the target object corresponds to a plurality of predetermined objects belonging to a same object sub-category, and different predetermined objects correspond to different object sources.

3. The method of claim 2, wherein an image resource which the image resource information belongs to comprises an associated video of the target object, the object unit comprises a video presentation area, and the video presentation area is configured to present a video cover of the associated video and/or play the associated video; and/or
object attribute information of the target object comprises target aggregation information, and the target aggregation information is obtained based on aggregating predetermined object attribute information of a plurality of corresponding predetermined objects in respective object sources.

4. The method of claim 3, wherein the associated video comprises a video satisfying a predetermined condition and containing an explanation content of the target object, wherein the predetermined condition is determined based on a video popularity attribute; and/or
the object unit comprises at least one attribute identifier, and the attribute identifier is configured to represent an attribute which a corresponding target object has.

5. The method of claim 4, wherein the object unit comprises explanation summary information of a corresponding associated video, the explanation summary information comprises text information corresponding to a target explanation speech in the associated video, and a corresponding explanation time of the target explanation speech in the associated video, and the target explanation speech is associated with a characteristic of the target object.

6. The method of claim 3, wherein the associated video and/or the attribute identifier is associated with a historical interaction operation of a current user.

7. The method of claim 2, further comprising:
displaying a predetermined control in an associated area of the set of object units in the target page;
presenting a first set of predetermined object information in response to a trigger operation for the predetermined control, wherein the first set of predetermined object information comprises predetermined object information of a plurality of predetermined objects matching the object search information.

8. The method of claim 2, further comprising: after presenting a set of object units in a search result presentation page,
presenting, in response to a trigger operation for a first target object unit, an associated page of a target object source corresponding to a first target object which corresponds to the first target object unit, wherein the associated page is configured for use by a current user to perform a predetermined interaction operation for a predetermined object corresponding to the target object source; and/or
presenting, in response to a trigger operation for a second target object unit, a second set of predetermined object information, wherein the second set of predetermined object information comprises predetermined object information of a plurality of predetermined objects corresponding to a second target object which corresponds to the second target object unit.

9. The method of claim 5, further comprising:
presenting a set of labels in the search result presentation page, wherein the set of labels comprises at least two labels, the labels which are different correspond to a set of object units of different predetermined attribute dimensions, and the labels are configured to trigger presenting of a set of object units of a corresponding predetermined attribute dimension.

10. The method of claim 9, wherein a characteristic of the target object comprises a content of a label corresponding to a set of object units which corresponds to the target object.

11. An electronic device, comprising:
one or more processors;
a storage apparatus, configured to store one or more programs,
wherein the one or more programs, when executed by the one or more processors, cause the one or more processors to perform at least:
obtaining object search information;
in response to the object search information being object category information, determining a target object category corresponding to the object search information, and presenting object information of a plurality of target objects corresponding to the target object category in a search result presentation page; wherein all the plurality of target objects are different, and object information of a target object comprises object attribute information and image resource information of the target object.

12. The electronic device of claim 11, wherein the presenting object information of a plurality of target objects corresponding to the target object category in a search result presentation page comprises:
presenting a set of object units in a search result presentation page, wherein the set of object units comprises a plurality of object units, the object unit is configured to present object information of a target object corresponding to the target object category, the target object corresponds to a plurality of predetermined objects belonging to a same object sub-category, and different predetermined objects correspond to different object sources.

13. The electronic device of claim 12, wherein an image resource which the image resource information belongs to comprises an associated video of the target object, the object unit comprises a video presentation area, and the video presentation area is configured to present a video cover of the associated video and/or play the associated video; and/or
object attribute information of the target object comprises target aggregation information, and the target aggregation information is obtained based on aggregating predetermined object attribute information of a plurality of corresponding predetermined objects in respective object sources.

14. The electronic device of claim 13, wherein the associated video comprises a video satisfying a predetermined condition and containing an explanation content of the target object, wherein the predetermined condition is determined based on a video popularity attribute; and/or
the object unit comprises at least one attribute identifier, and the attribute identifier is configured to represent an attribute which a corresponding target object has.

15. The electronic device of claim 14, wherein the object unit comprises explanation summary information of a corresponding associated video, the explanation summary information comprises text information corresponding to a target explanation speech in the associated video, and a corresponding explanation time of the target explanation speech in the associated video, and the target explanation speech is associated with a characteristic of the target object.

16. The electronic device of claim 13, wherein the associated video and/or the attribute identifier is associated with a historical interaction operation of a current user.

17. The electronic device of claim 12, wherein the one or more processors are further caused to perform:
displaying a predetermined control in an associated area of the set of object units in the target page;
presenting a first set of predetermined object information in response to a trigger operation for the predetermined control, wherein the first set of predetermined object information comprises predetermined object information of a plurality of predetermined objects matching the object search information.

18. The electronic device of claim 12, wherein the one or more processors are further caused to perform: after presenting a set of object units in a search result presentation page,
presenting, in response to a trigger operation for a first target object unit, an associated page of a target object source corresponding to a first target object which corresponds to the first target object unit, wherein the associated page is configured for use by a current user to perform a predetermined interaction operation for a predetermined object corresponding to the target object source; and/or
presenting, in response to a trigger operation for a second target object unit, a second set of predetermined object information, wherein the second set of predetermined object information comprises predetermined object information of a plurality of predetermined objects corresponding to a second target object which corresponds to the second target object unit.

19. The electronic device of claim 15, wherein the one or more processors are further caused to perform:
presenting a set of labels in the search result presentation page, wherein the set of labels comprises at least two labels, the labels which are different correspond to a set of object units of different predetermined attribute dimensions, and the labels are configured to trigger presenting of a set of object units of a corresponding predetermined attribute dimension.

20. A non-transitory storage medium comprising computer-executable instructions, wherein when executed by a computer processor, the computer-executable instructions are configured to perform at least:
obtaining object search information;
in response to the object search information being object category information, determining a target object category corresponding to the object search information, and presenting object information of a plurality of target objects corresponding to the target object category in a search result presentation page; wherein all the plurality of target objects are different, and object information of a target object comprises object attribute information and image resource information of the target object.
